(19) United States
(12) Patent Application Publication
(10) Pub. No.: US 2025/0321796 A1
(43) Pub. Date: Oct. 16, 2025

(54) METHOD, DEVICE, AND COMPUTER PROGRAM PRODUCT FOR ASSIGNING TASKS TO ACCELERATION DEVICES

(71) Applicant: Dell Products L.P., Round Rock, TX (US)

(72) Inventors: Jet Chen, Beijing (CN); Jiang Cao, Shanghai (CN); Xingshan Wang, Shanghai (CN); Chark Yu, Shanghai (CN); Qi Chen, Beijing (CN); Wei Lu, Beijing (CN); Long Wang, Beijing (CN)

(21) Appl. No.: 18/680,749

(22) Filed: May 31, 2024

(30) Foreign Application Priority Data
Apr. 12, 2024 (CN) 202410444804.4

(51) Int. Cl. G06F 9/50; G06F 9/48

(52) U.S. Cl. CPC G06F 9/5027; G06F 9/4881

(57) ABSTRACT

The described technology relates to assigning tasks to acceleration devices. For instance, an example method includes determining a target task to be assigned to multiple acceleration devices of a storage system. Here, the acceleration devices are configured to handle various types of tasks. The method further includes determining multiple corresponding computing resources required or requested to perform multiple corresponding task queues of the multiple acceleration devices. The method further includes selecting a target acceleration device from the multiple acceleration devices based on the multiple computing resources. The method further includes assigning the target task to the target acceleration device. Using the described technology, the scheduling of target tasks can be optimized on the multiple acceleration devices and the computing resources can be assigned more reasonably, thereby optimizing the system performance.

### RELATED APPLICATION

The present application claims the benefit of priority to Chinese Patent Application No. 202410444804.4, filed on Apr. 12, 2024, which application is hereby incorporated into the present application by reference herein in its entirety.

### TECHNICAL FIELD

Embodiments of the present disclosure generally relate to the field of data storage, and, for instance, to assigning tasks to acceleration devices.

### BACKGROUND

With the development of storage technology, the architecture of storage systems becomes more and more complicated. Accordingly, in the data path of a storage system in the related art, there are many steps that need complicated computations. A great number of complicated computations bring great stress to the central processor (CPU) of the storage system.

In view of this, acceleration devices are deployed in the storage system to assist in the computation of the CPU. Acceleration devices refer to some processing resources with an acceleration function, such as a co-processor, which can assist the CPU in performing some acceleration tasks. A co-processor is a chip that is capable of relieving a system CPU of a specific processing task. For example, a math co-processor can perform digital processing, and a graphics co-processor (GPU) can handle video rendering. A co-processor that can be used in the storage system is, for example, a Quick Assist Technology (QAT) card, which can be used to speed up computation-intensive tasks, such as compression, encryption, decryption, and the like. By adding a QAT device to a node, the computation of the node can be sped up, and the performance and efficiency of the system can be improved.

### SUMMARY

Embodiments of the present disclosure provide a solution for assigning tasks to acceleration devices based on computing resources required or requested by the tasks.

In a first example embodiment of the present disclosure, a method for assigning tasks to acceleration devices is provided. The method includes determining a target task to be assigned to multiple acceleration devices of a storage system. Here, the acceleration devices are configured to handle various types of tasks. The method further includes determining multiple corresponding computing resources required or requested to perform multiple corresponding task queues of the multiple acceleration devices. The method further includes selecting a target acceleration device from the multiple acceleration devices based on the multiple computing resources for the multiple task queues. The method further includes assigning the target task to the target acceleration device.

In a second example embodiment of the present disclosure, an electronic device is provided. The electronic device includes at least one processing unit and at least one memory. The at least one memory is coupled to the at least one processing unit and stores instructions to be executed by the at least one processing unit. The instructions, when executed by at least one processing unit, cause the electronic device to perform actions including determining a target task to be assigned to multiple acceleration devices of a storage system. Here, the acceleration devices are configured to handle various types of tasks. The actions further include determining multiple corresponding computing resources required or requested to perform multiple corresponding task queues of the multiple acceleration devices. The actions further include selecting a target acceleration device from the multiple acceleration devices based on the multiple computing resources for the multiple task queues. The actions further include assigning the target task to the target acceleration device.

In a third example embodiment of the present disclosure, a computer program product is provided. The computer program product is tangibly stored in a non-transitory computer storage medium and includes machine-executable instructions. The machine-executable instructions, when executed by a device, cause the device to perform one or more operations, comprising determining a target task to be assigned to multiple acceleration devices of a storage system, where the acceleration devices can be configured to handle various types of tasks, determining multiple corresponding computing resources required or requested to perform multiple corresponding task queues of the multiple acceleration devices, selecting a target acceleration device from the multiple acceleration devices based on the multiple computing resources for the multiple task queues, and assigning the target task to the target acceleration device.

This Summary is provided to introduce in a simplified form the selection of concepts, which will be further described in the Detailed Description below. This Summary is neither intended to identify key features or essential features of the present disclosure, nor intended to limit the scope of the present disclosure.

### BRIEF DESCRIPTION OF THE DRAWINGS

The above and other objectives, features, and advantages of the present disclosure will become more apparent from the description of example embodiments of the present disclosure in further detail with reference to the accompanying drawings, and in the example embodiments of the present disclosure, the same reference numerals generally represent the same components.

FIG. 1 illustrates a schematic diagram of an example system in which some embodiments of the present disclosure can be implemented;

FIG. 2 illustrates a flow chart of an example method for assigning tasks to acceleration devices according to some embodiments of the present disclosure;

FIG. 3 illustrates a flow chart of an example method for determining a resource weight according to some embodiments of the present disclosure;

FIG. 4 illustrates a schematic diagram of an example process of determining a resource weight according to some embodiments of the present disclosure;

FIG. 5 illustrates a schematic diagram of an example process of assigning tasks to acceleration devices according to some embodiments of the present disclosure; and

FIG. 6 illustrates a schematic block diagram of an example device that can be used to implement embodiments of the present disclosure.

In various accompanying drawings, identical or corresponding reference numerals represent identical or corresponding parts.

### DETAILED DESCRIPTION

Example embodiments of the present disclosure will be described in further detail below with reference to the accompanying drawings. Although the example embodiments of the present disclosure are shown in the accompanying drawings, it should be understood that the present disclosure may be implemented in various forms and should not be limited by the embodiments stated herein. Rather, these embodiments are provided to make the present disclosure more thorough and complete and to fully convey the scope of the present disclosure to those skilled in the art.

The term “include” and variants thereof used herein indicate open-ended inclusion, that is, “including but not limited to.” Unless specifically stated, the term “or” means “and/or.” The term “based on” means “based at least in part on.” The terms “an example embodiment” and “an embodiment” mean “at least one example embodiment.” The term “another embodiment” means “at least one additional embodiment.” The terms “first,” “second,” and the like may refer to different or identical objects. Other explicit and implicit definitions may also be included below.

As discussed above, acceleration devices can be deployed in a storage system. However, the computing resources that a single acceleration device can provide are still limited. Therefore, multiple acceleration devices and a scheduler for assigning tasks to the acceleration devices are usually deployed. Upon receiving a task request, the scheduler selects an acceleration device and assigns the received task to the acceleration device. Therefore, it is essential to submit requests in a load-balanced way to optimize the performance.

In the related art, tasks to be performed on the acceleration devices are usually scheduled in a round robin mode. During scheduling in the round robin mode, the scheduler assigns the received task requests to all the acceleration devices in a sequential and circular manner, so that the numbers of tasks in the task queues of all the acceleration devices are nearly in balance. However, in this way, although the number of requests handled by each acceleration device is roughly in balance, this is not an ideal form of load balancing in terms of computing resource consumption. This is because the computing resources consumed by different types of computing tasks to be performed by the acceleration devices vary from each other.

For example, when a specific acceleration device is performing a compression task, the maximum throughput of each socket can reach 160 Gbps, while when handling an encryption task, the maximum throughput of each socket can reach 400 Gbps. This means that the computing resource required or requested to perform the compression task may be 2.5 times that of the encryption task. On this basis, suppose a storage system has three such acceleration devices, such as a first acceleration device, a second acceleration device, and a third acceleration device, and the tasks to be performed on the acceleration devices are of many different task types. In the case of assignment in the round robin mode, the tasks assigned to a first acceleration device may all be compression tasks, while the tasks assigned to a second acceleration device may all be encryption tasks. In this case, the computing resource required or requested to perform all the tasks in the task queue of the first acceleration device is far more than that required or requested to perform all the tasks in the task queue of the second acceleration device. As a result, the second acceleration device is in idle status after completing all the tasks, while the first acceleration device still has multiple tasks to perform, resulting in waste of computing resources.

In view of this, the embodiments of the present disclosure propose a solution for assigning tasks to acceleration devices based on computing resources. In this solution, upon receiving a task request, a computing resource required or requested to perform the task queue of each acceleration device is determined, and the target acceleration device suitable for receiving the task request is selected based on the determined computing resource.

In this way, compared with the simple cyclic round robin method, by selecting a computing device based on the required or requested computing resource, it is possible to provide good load balance among acceleration devices, thereby improving the overall performance. In addition, users can flexibly select an acceleration device according to the system configuration and load condition to adapt to different requirements.

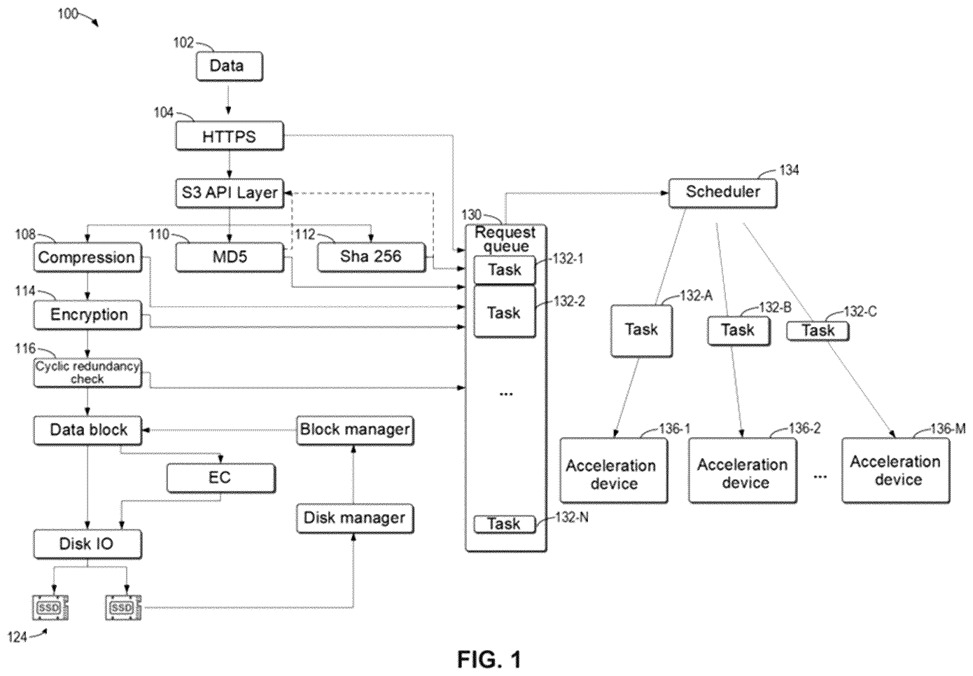

Hereinafter, the solution for assigning tasks to acceleration devices based on required or requested computing resources according to embodiments of the present disclosure will be described with reference to FIGS. 1 to 5. FIG. 1 illustrates a schematic diagram of an example system 100 in which some embodiments of the present disclosure can be implemented. As shown in FIG. 1, the storage system 100 is an object storage system. The storage system 100 includes a data path from receiving data 102 until the data is written to a solid state disk SSD 124.

When the storage system 100 receives a write request for the data 102 from a user, the data 102 is first at the hypertext transfer protocol security (HTTPS) layer. In the HTTPS layer, CPU-intensive computation for the data 102 involves decryption (in HTTPS 104), compression 108, encryption 114, and hashing computation (including MD5 computation 110 and SHA256 computation 112). These computations are performed on each segment of data 102 to ensure data integrity and protection. To ensure data integrity, OBS performs hashing computations, such as SHA256, MD5, and CRC checksums. These computations are used to verify the correctness of the data. In terms of data protection with space efficiency, the storage system 100 writes all the data into blocks with erasure coding (EC) protection. This helps to ensure efficient space use while still providing data protection. It should be understood that the system illustrated in FIG. 1 is only an example. In practical applications, more other devices and/or components in a device may exist in the storage system, or the illustrated devices and/or components may be arranged in other manners.

As the data 102 traverses operations in the data path, a decryption task request is generated at the HTTPS layer 104. At the compression module 108, a compression task request is generated. At the MD5 computation module 110 and SHA256 computation module 112, corresponding hashing task requests are generated respectively. The generated task requests are sent to a request queue 130. In the embodiment shown in FIG. 1, the request queue 130 includes multiple (e.g., N) tasks 132-1, 132-2, . . . , 132-N (referred to collectively or individually as the task 120), where N is an integer that is more than 1. Because the task requests submitted by different modules are of different task types, the computing resources to be consumed by the tasks may be different. In this embodiment, the area of the box representing the task 132 is used to indicate the computing resource required or requested to perform the task. For example, the computing resource required or requested to perform the task 132-1 is less than that required or requested to perform the task 132-2.

As shown in FIG. 1, the storage system 100 further includes a scheduler 134 and multiple (e.g., M) acceleration devices 136-1, 136-2, . . . , 136-M, where M is an integer more than 1. Hereinafter, for the convenience of discussion, the acceleration devices 136-1, 136-2, . . . , 136-M are sometimes referred to collectively or individually as the acceleration device 136. The scheduler 134 is configured to assign the tasks 136 in the request queue 130 to multiple acceleration devices 136. Accordingly, each acceleration device 136 is configured to perform various tasks 132 of the storage system 100. Herein, tasks are also referred to as jobs, requests, or instances. In some embodiments, the acceleration device 110 may be one or more QAT devices. It should be understood that although the QAT device is used as an example of the acceleration device in some embodiments of the present disclosure, the acceleration device 110 may also include other hardware processing devices having an acceleration function.

In the embodiment shown in FIG. 1, when the scheduler 134 receives a task request from the request queue 130, the scheduler 134 can determine the condition of the task queue of each acceleration device 136, so as to determine the computing resource required or requested to perform all the tasks in the task queue of each acceleration device 136. For example, after determining the computing resources required or requested by all the acceleration devices 136, the scheduler 134 determines that the computing resource required or requested by the acceleration device 136-1 is less than that required or requested by the acceleration device 136-2, and that the computing resource required or requested by the acceleration device 136-2 is less than that required or requested by the acceleration device 136-M. Therefore, the acceleration device 136-1 can assign the task 132-A requiring or requesting the most computing resource in the task request queue 130 to the acceleration device 136-1, the task 132-B requiring or requesting the second most computing resource to the acceleration device 136-2, and finally the task 132-C requiring or requesting the third most computing resource to the acceleration device 136-M, thus making the task loads on the acceleration devices 136 more balanced, preventing waste of computing resources.

It should be understood that the storage system 100 shown in FIG. 1 is merely an example and not limiting. The storage system according to the present disclosure may also have other forms or structures. The scheduler 132 may be a logical module and may be embodied as a computing device (such as a CPU) of the storage system 100.

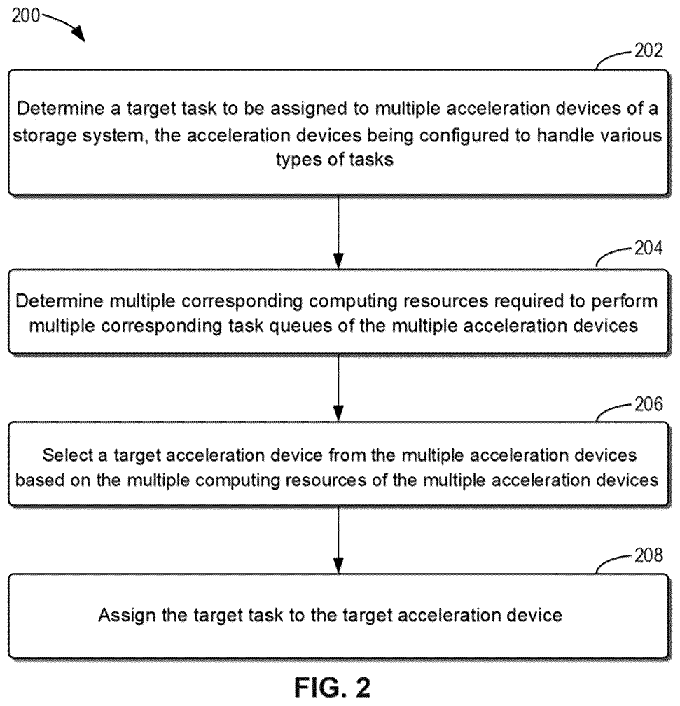

FIG. 2 illustrates a flow chart of an example method 200 of assigning tasks to acceleration devices according to some embodiments of the present disclosure. It should be understood that the method 200 can be performed by appropriate devices or apparatuses. The method 200 may include additional actions not shown and/or may omit actions shown, and the scope of the present disclosure is not limited in this regard. For ease of description, the method 200 will be described with reference to FIG. 1. For example, the method 200 may be implemented by a device of the storage system 100. In the embodiment shown in FIG. 1, the method 200 may be performed by the scheduler 132.

As shown in FIG. 2, at 202, the method 200 includes determining a target task to be assigned to multiple acceleration devices of a storage system. Here, the acceleration devices are configured to handle various types of tasks. For example, in the embodiment shown in FIG. 1, the storage system 100 may determine a target task to be assigned to multiple acceleration devices 136 in the storage system 100. The target task may be the first task in the task request list 130.

At 204, the method 200 includes determining multiple corresponding computing resources required or requested to perform multiple corresponding task queues of the multiple acceleration devices. For example, in the embodiment shown in FIG. 1, the storage system 100 can determine the computing resources required or requested to perform all tasks in the task queue of each computing device 136 among multiple acceleration devices 136, so as to determine the multiple corresponding computing resources required or requested by the multiple task queues.

In some embodiments, the computing resource required or requested to perform a specific task may be determined based on the size of the task and the type of the task when the specific task is received. In this embodiment, the computing resource consumed by an acceleration device when performing a specific type of tasks is fixed or statistically stable. Accordingly, with a determined size and type of the task, the computing resource for performing the task can be calculated. It should be understood that the computing resource may include the actually required computing resource or may be any index representing the computing resource.

In some embodiments, the storage system 100 may be a paged storage system. In this storage system, the task performed by the acceleration device may be directed to data of a predetermined size. For example, write data received by the storage system 100 from a user for writing into the storage system is divided into multiple segments of data of a predetermined size in the storage system 100. When the write data traverses the data path, the generated task requests are all directed to the multiple segments of data. Meanwhile, in a storage system, the types of tasks assigned to the acceleration devices are fixed. Accordingly, in the case of performing a fixed type of tasks on each segment of data of the same size, the computing resources consumed by the same type of tasks are the same. Accordingly, the computing resource required or requested to perform each kind of tasks in the storage system 100 is fixed.

In some embodiments, the computing resource required or requested by the task queue of each acceleration device can be maintained in the resource requirement list. In this embodiment, the sum of computing resources required by all the tasks in the current task list of each acceleration device is recorded in the resource requirement list. When a new task is included in the task list, the recorded computing resources are updated by adding the computing resource required or requested by the new task. In contrast, when a task in the task list is completed, the recorded computing resources are updated by subtracting the computing resource required or requested by the completed task. Thus, the scheduler can determine the computing resource required or requested to perform a task in the task list of the acceleration device by accessing the resource requirement list.

At 206, the method 200 includes selecting a target acceleration device from the multiple acceleration devices based on the multiple computing resources for the multiple task queues. For example, in the embodiment shown in FIG. 1, the storage system 100 can select a target acceleration device from the multiple acceleration devices based on the computation resources determined to be required or requested to perform the tasks in the task list of each acceleration device. In some embodiments, the storage system may select the acceleration device with the least computing resource as the target acceleration device. In such an embodiment, load balance among the acceleration devices can be ensured in a simple manner. In some alternative embodiments, the storage system can select the target acceleration device based on the computing resource required or requested by the target task in combination with the computing resources required or requested by various acceleration devices. For example, the storage system can calculate the computing resource required or requested by the target task after it is assigned to the first acceleration device, and calculate the variance or standard deviation between the computing resources required or requested by the multiple acceleration devices at this time. After obtaining the variance or standard deviation calculated after the target task is assigned to each computing device, the acceleration device assigned with the target task in the assignment scheme with the smallest variance or standard deviation is selected as the target acceleration device.

At 208, the method 200 includes assigning the target task to the target acceleration device. For example, in the embodiment shown in FIG. 1, the storage system 100 can assign the target task to the target acceleration device. In the embodiment shown in FIG. 2, by determining the computing resource required or requested by each acceleration device to perform the current task queue, and selecting the target acceleration device based on the determined computing resource, an assignment scheme optimized in terms of computing resource consumption can be obtained, so that the computing resource of each acceleration device can be better utilized and the waste of computing resources can be avoided. As a result, the overall performance of the storage system has been improved accordingly.

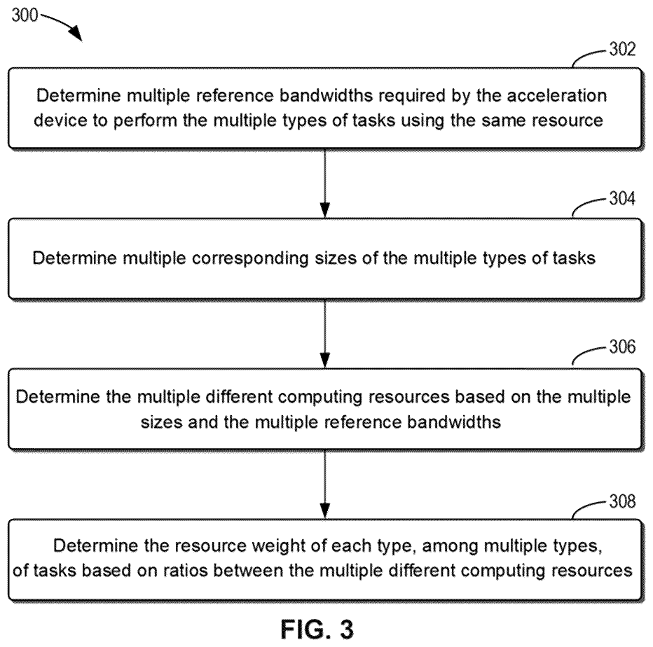

As discussed above, the computing resource can be characterized by other forms of indicators, and in some embodiments, the computing resource can be characterized by a weight associated with a task type. A solution for characterizing the computing resource will be described below with reference to FIG. 3. FIG. 3 illustrates a flow chart 300 of an example method for determining a resource weight according to some embodiments of the present disclosure. It should be understood that method 300 can be performed by appropriate devices or apparatuses. The method 300 may include additional actions not shown and/or may omit actions shown, and the scope of the present disclosure is not limited in this regard. For ease of description, the method 300 will be described with reference to FIG. 1. For example, the method 300 may be implemented by a device of the storage system 100.

As shown in FIG. 3, at 302, the storage system 100 determines multiple reference bandwidths required or requested by the acceleration device to perform multiple types of tasks using the same resource. Here, the storage system 100 can control the acceleration device to perform each type, among the multiple types, of tasks, and monitor the bandwidth or throughput when performing the tasks, so as to obtain the bandwidth per unit resource as the reference bandwidth.

At 304, the storage system 100 determines multiple corresponding sizes of the multiple types of tasks. At 306, the storage system 100 determines multiple different computing resources based on the multiple sizes and the multiple reference bandwidths. In this embodiment, after determining the size of the task, the storage system can use the size of the task to determine how many units of reference bandwidth are required or requested. In some embodiments, the unit of resource may be a socket.

At 308, the storage system 100 determines the resource weight of each type, among multiple types, of tasks based on the ratios between the multiple different computing resources. Here, the resource weight characterizes the required or requested computing resources. In this embodiment, the storage system can perform a normalization operation based on the ratios between the computing resources required or requested by every two types of tasks, so that the weight assigned to each type of tasks is an integer. For example, the ratio of the computing resource required or requested by the first type of tasks to that required or requested by the second type of tasks is 1 to 2, and the ratio of the computing resource required or requested by the third type of tasks to that required or requested by the second type of tasks is 2 to 5. Based on this, the storage system can determine that the resource weight of the computing resource required or requested by the first type of tasks is 4, the resource weight of the computing resource required or requested by the second type of tasks is 10, and the resource weight of the computing resource required or requested by the third type of tasks is 5. In a more general case, the weight of the reference bandwidth can be determined based on the ratios between the reference bandwidths of different types of tasks. Then, based on the ratio of the task size to the unit task size, the weight of the task is determined.

In this way, by assigning a weight to each type of tasks based on the ratios of the computing resources required or requested to perform the tasks, the calculation of computing resources and the maintenance of the computing resource list can be simplified.

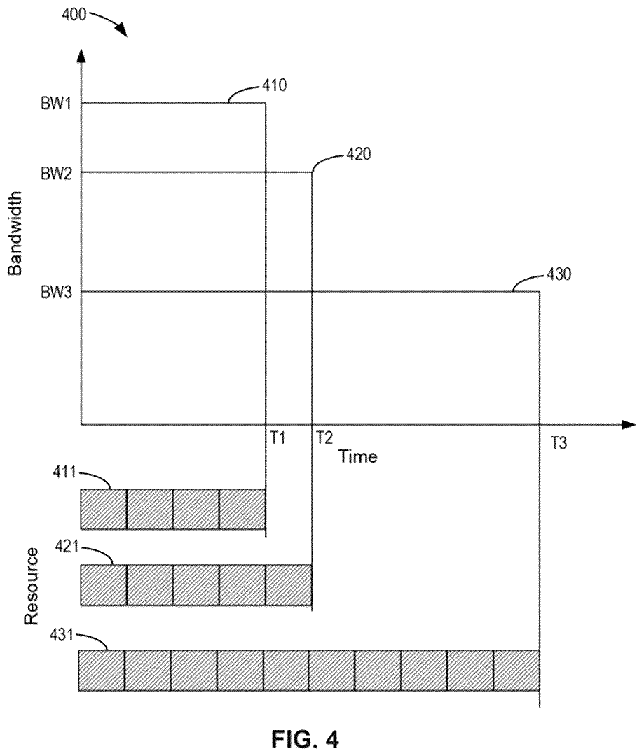

In addition, as discussed above, in a storage system that uses a QAT device as an acceleration device, the computing resources required or requested to perform the same type of tasks are the same, and the size of data targeted by each task is also the same. In such an embodiment, the rule of resource weight assignment can be greatly simplified. Hereinafter, a solution for determining the resource weight in the case where the data sizes of the tasks are the same will be described with reference to FIG. 4. FIG. 4 illustrates a schematic diagram of an example process 400 of determining a resource weight according to some embodiments of the present disclosure.

As shown in FIG. 4, in the storage system, there are three types of tasks. The storage system controls the acceleration devices to perform each type of tasks with the same computing resources, and records the bandwidth and time in performing the corresponding tasks. Here, the required or requested computing resource is directly proportional to the time. As shown in FIG. 4, the acceleration device records a curve 410 of the throughput over time in performing a first type of tasks, such as an encryption task. According to the curve 410, when the first type of tasks is being performed, the bandwidth or throughput per socket is BW1, for example, 400 Gbps, and the time spent is T1. The acceleration device records a curve 420 of throughput over time in performing a second type of task, such as a hashing task. According to the curve 420, when the second type of tasks is being performed, the bandwidth or throughput per socket is BW2, for example, 320 Gbps, and the time spent is T2.

Since the size of the data targeted by the tasks is the same, the time T2 spent in performing the second task is longer than the time T1 and is inversely proportional to the throughput of a unit socket. Therefore, it can be calculated that the ratio of time spent is 320:400, that is, 4:5. Furthermore, according to the direct proportional relationship between the time and the computing resource, it can be calculated that the ratio of the computing resource 411 required or requested to perform the first type of tasks to the computing resource 421 required or requested to perform the second type of task is 4:5.

In addition, the acceleration device records a curve 430 of throughput over time when performing a third task, such as a compression task. According to the curve 430, when the third type of tasks is being performed, the bandwidth or throughput per socket is BW3, for example, 160 Gbps, and the time spent is T3. Based on calculations similar to those for the first and second types of tasks, it can be determined that the ratio of T2 to T3 is 160:320, that is, 1:2, and the ratio of the computing resource 421 required or requested to perform the second type of tasks to the computing resource 431 required or requested to perform the third type of tasks is also 1:2. In combination with the ratio of 4:5 between the computing resources 411 and 421, it can be determined that the ratio between the computing resources 411, 421, and 431 is 4:5:10. Based on this, the first type of tasks can be assigned a resource weight of 4, the second type of tasks can be assigned a resource weight of 5, and the third type of tasks can be assigned a resource weight of 10.

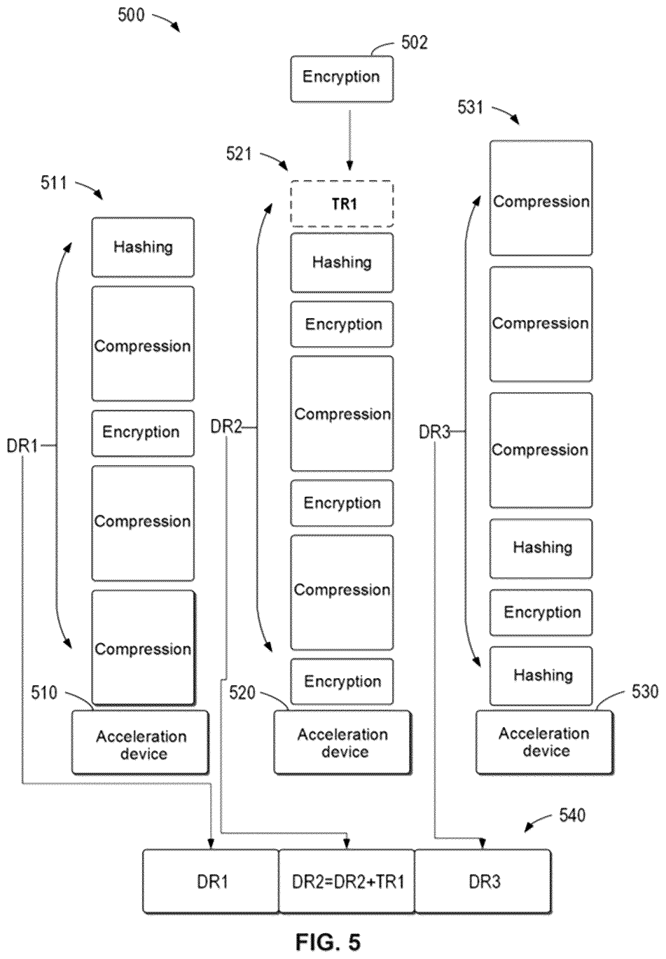

In the following, with reference to FIG. 5, a solution for assigning tasks to acceleration devices in the case where resource weights are determined will be described in combination with the embodiment shown in FIG. 4. FIG. 5 illustrates a schematic diagram of an example process 500 of assigning tasks to acceleration devices according to some embodiments of the present disclosure.

As shown in FIG. 5, the storage system performing the process 500 includes three acceleration devices, i.e., an acceleration device 510, an acceleration device 520, and an acceleration device 530. The tasks to be performed by the acceleration devices include three types of tasks, i.e., encryption tasks and compression tasks. The task queue 511 of the acceleration device 510 includes three compression tasks, one encryption task, and one hashing task. The task queue 521 of the acceleration device 520 includes two compression tasks, three encryption tasks, and one hashing task. The task queue 531 of the acceleration device 530 includes three compression tasks, one encryption task, and two hashing tasks.

Here, the resource weight assignment result shown in FIG. 4 is utilized, where the resource weight of the encryption task is 4, the resource weight of the compression task is 10, and the resource weight of the hashing task is 5. Therefore, the resource weight DR1 of the computing resources required or requested to perform the task queue 511 is 10×3+4+5, i.e., 39. The resource weight DR1 of the computing resources required or requested to perform the task queue 521 is 10×2+4×3+5, i.e., 37. The resource weight DR3 of the computing resources required or requested to perform the task queue 531 is 10×3+4+5×2, i.e., 44. In this embodiment, DR1, DR2, and DR3 are maintained in the resource requirement list 540.

In contrast, the storage system can determine that the task queue of the acceleration device 520 requires or requests the least computing resources. Therefore, the storage system selects the acceleration device 520 as the target acceleration device and assigns the encryption task 502 to the acceleration device 520. The resource weight of the encryption task 502 is TR1. After the encryption task 502 is assigned to the task list 521, the resource weight DR2 in the resource requirement list 540 is updated by being added with TR1.

In the embodiment shown in FIG. 5, the computing resources required or requested by the task list of each acceleration device, such as the QAT device, are maintained in the corresponding list in the form of weights. When a new task request is received, the condition of load on each acceleration device can be quickly determined by looking up the table, so that the target acceleration device can be selected based on the load, thus balancing the loads on the multiple acceleration devices in the storage system, avoiding the waste of computing resources and further improving the performance of the storage system.

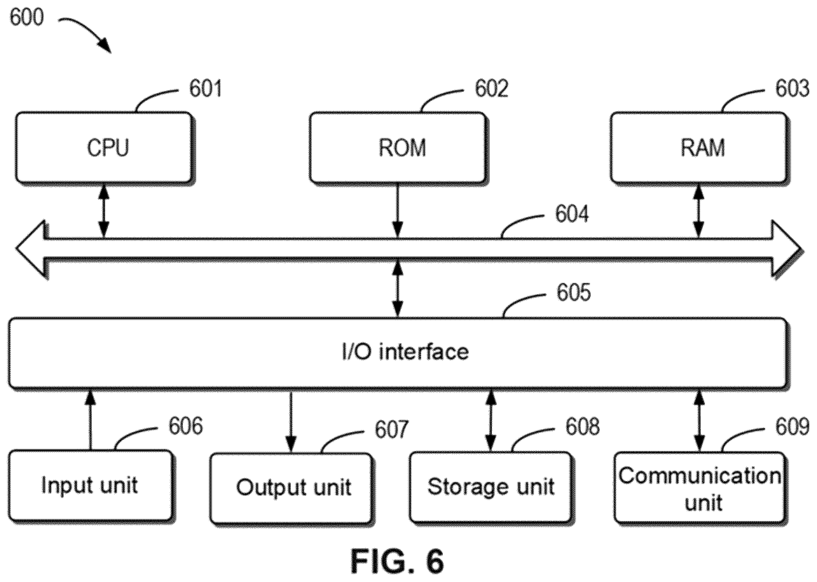

FIG. 6 illustrates a schematic block diagram of an example device 600 that can be used to implement the embodiments of the present disclosure. For example, the storage system 100 as shown in FIG. 1 can be implemented by the device 600. As shown in FIG. 6, the device 600 includes a central processing unit (CPU) 601 that can perform various appropriate actions and processing according to computer program instructions stored in a read-only memory (ROM) 602 or computer program instructions loaded from a storage unit 608 to a random access memory (RAM) 603. Various programs and data required for the operation of the storage device 600 may also be stored in the RAM 603. The CPU 601, the ROM 602, and the RAM 603 are connected to each other through a bus 604. An input/output (I/O) interface 605 is also connected to the bus 604.

Multiple components in the device 600 are connected to the I/O interface 605, including: an input unit 606, such as a keyboard, a mouse, and the like; an output unit 607, such as various types of displays, speakers, and the like; the storage unit 608, such as a magnetic disk, an optical disc, and the like; and a communication unit 609, such as a network card, a modem, a wireless communication transceiver, and the like. The communication unit 609 allows the device 600 to exchange information/data with other devices via a computer network, such as the Internet, and/or various telecommunication networks.

The various processes and processing described above, such as the methods 200 and 300, can be performed by the processing unit 601. For example, in some embodiments, the methods 200 and 300 can be embodied as a computer software program that is tangibly included in a machine-readable medium such as the storage unit 608. In some embodiments, part of or all the computer program can be loaded and/or installed onto the device 600 via the ROM 602 and/or the communication unit 609. When the computer program is loaded to the RAM 603 and executed by the CPU 601, one or more actions of the method 300 described above can be performed.

The present disclosure may be a method, an apparatus, a system, and/or a computer program product. The computer program product may include a computer-readable storage medium on which computer-readable program instructions, for performing various example embodiments of the present disclosure, are loaded.

The computer-readable storage medium may be a tangible device that can maintain and store instructions to be used by an instruction execution device. For example, the computer-readable storage medium may be, but is not limited to, an electric storage device, a magnetic storage device, an optical storage device, an electromagnetic storage device, a semiconductor storage device, or any suitable combination thereof. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination thereof. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein can be downloaded from a computer-readable storage medium to various computing/processing devices, or downloaded to an external computer or external storage device through a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in various computing/processing devices.

Computer program instructions for performing the operations of the present disclosure may be assembly instructions, Instruction Set Architecture (ISA) instructions, machine instructions, machine-related instructions, microcode, firmware instructions, state setting data, or source code or object code written in any combination of one or more programming languages, including object-oriented programming languages such as Smalltalk and C++, and conventional procedural programming languages such as “C” language or the like. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (e.g., connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit can execute the computer-readable program instructions so as to implement various example embodiments of the present disclosure.

Various example embodiments of the present disclosure are described herein with reference to flow charts and/or block diagrams of the method, apparatus (system), and computer program product according to the embodiments of the present disclosure. It should be understood that each block of the flow charts and/or the block diagrams and combinations of blocks in the flow charts and/or the block diagrams may be implemented by the computer-readable program instructions.

These computer-readable program instructions may be provided to a processing unit of a general-purpose computer, a special-purpose computer, or other programmable data processing apparatuses to produce a machine, such that these instructions, when executed by the processing unit of the computer or other programmable data processing apparatuses, produce means for implementing the functions/acts specified in one or more blocks in the flow charts and/or block diagrams. These computer-readable program instructions may also be stored in a computer-readable storage medium, and cause a computer, a programmable data processing apparatus, and/or other devices to function in a particular manner, so that the computer-readable medium having the instructions stored thereon includes an article of manufacture including instructions for implementing various example embodiments of the functions/acts specified in one or more blocks in the flow charts and/or block diagrams.

The computer-readable program instructions may also be loaded onto a computer, other programmable data processing apparatuses, or other devices, such that a series of operational steps are performed on the computer, other programmable data processing apparatuses, or other devices to produce a computer-implemented process, such that the instructions executed on the computer, other programmable data processing apparatuses, or other devices implement the functions/actions specified in one or more blocks in the flow charts and/or block diagrams.

The flow charts and block diagrams in the drawings show the architectures, functions, and operations of possible implementations of the systems, methods, and computer program products according to multiple embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on the functions involved. It should be further noted that each block in the block diagrams and/or flow charts as well as a combination of blocks in the block diagrams and/or flow charts may be implemented using a dedicated hardware-based system that performs specified functions or actions, or using a combination of dedicated hardware and computer instructions.

The embodiments of the present disclosure have been described above. The above description is illustrative, rather than exhaustive, and is not limited to the disclosed various embodiments. Numerous modifications and alterations are apparent to persons of ordinary skill in the art without departing from the scope and spirit of the illustrated embodiments. The terminology used herein is chosen to best explain the principles and practical application of various embodiments or improvement of technologies in the market, or to enable those of ordinary skill in the art to understand various embodiments disclosed herein.

What is claimed is:

1. A method, comprising:
determining, by a system comprising at least one processor, a target task to be assigned to acceleration devices of a storage system, the acceleration devices being configured to handle types of tasks;
determining corresponding computing resources required or requested to perform corresponding task queues of the acceleration devices;
based on the computing resources for the corresponding task queues, selecting a target acceleration device from the acceleration devices; and
assigning the target task to the target acceleration device.

2. The method of claim 1, wherein determining the computing resources for the corresponding task queues comprises:
based on corresponding types of tasks in a first task queue among the corresponding task queues, determining the corresponding computing resources required or requested to perform the tasks;
based on the corresponding computing resources for the tasks, determining a first computing resource required or requested to perform the first task queue; and
based on the first computing resource for the first task queue, determining the corresponding computing resources for the corresponding task queues.

3. The method of claim 2, further comprising:
in response to a first task being added to a second task queue among the corresponding task queues, determining a third computing resource required or requested to perform the first task based on a first task type of the first task; and
updating a second computing resource required or requested to perform the second task queue by adding the third computing resource.

4. The method of claim 3, further comprising:
in response to a second task being removed from the second task queue, determining a fourth computing resource required or requested to perform the second task based on a second task type of the second task; and
updating the second computing resource for the second task queue by subtracting the fourth computing resource from the second computing resource for the second task queue.

5. The method of claim 1, wherein selecting the target acceleration device comprises:
selecting the acceleration device with a lowest computing resource among the acceleration devices as the target acceleration device.

6. The method of claim 1, further comprising:
determining different computing resources required or requested to perform the types of tasks; and
determining a resource weight of each type, among the types of tasks, based on ratios between the different computing resources, the resource weight characterizing the required or requested computing resource.

7. The method of claim 6, wherein determining the different computing resources comprises:
determining reference bandwidths required or requested when the acceleration device performs the types of tasks using a same resource;
determining corresponding sizes of the types of tasks; and
determining the different computing resources based on the corresponding sizes and the reference bandwidths.

8. The method of claim 1, further comprising:
receiving write data;
dividing the write data into parts of data with a predetermined size; and
submitting a request for a corresponding type, among the types, of tasks executed for the parts of data.

9. The method of claim 8, wherein the types of tasks comprise at least two of an encryption task, a decryption task, a compression task, a decompression task, or a hashing task.

10. The method of claim 1, wherein the acceleration devices each comprise a Quick Assist Technology (QAT) device.

11. A device, comprising:
at least one processor; and
at least one memory having computer program instructions stored thereon, the at least one memory and the computer program instructions being configured to, together with the at least one processor, cause the device to perform actions comprising:
determining a target task to be assigned to a plurality of acceleration devices of a storage system, the plurality of acceleration devices being configured to handle a plurality of types of tasks;
determining a plurality of corresponding computing resources required to perform a plurality of corresponding task queues of the plurality of acceleration devices;
based on the plurality of computing resources for the plurality of corresponding task queues, selecting a target acceleration device from the plurality of acceleration devices; and
assigning the target task to the target acceleration device.

12. The device of claim 11, wherein determining the plurality of computing resources for the plurality of corresponding task queues comprises:
based on corresponding types of a plurality of tasks in a first task queue among the plurality of corresponding task queues, determining the plurality of corresponding computing resources required to perform the plurality of tasks;
based on the plurality of corresponding computing resources for the plurality of tasks, determining a first computing resource required to perform the first task queue; and
based on the first computing resource for the first task queue, determining the plurality of corresponding computing resources for the plurality of corresponding task queues.

13. The device of claim 12, wherein the actions further comprise:
in response to a first task being added to a second task queue among the plurality of corresponding task queues, determining a third computing resource required to perform the first task based on a first task type of the first task; and
updating a second computing resource required to perform the second task queue by adding the third computing resource.

14. The device of claim 13, wherein the actions further comprise:
in response to a second task being removed from the second task queue, determining a fourth computing resource required to perform the second task based on a second task type of the second task; and
updating the second computing resource for the second task queue by subtracting the fourth computing resource from the second computing resource for the second task queue.

15. The device of claim 11, wherein selecting the target acceleration device comprises:
selecting the acceleration device with a lowest computing resource among the plurality of acceleration devices as the target acceleration device.

16. The device of claim 11, wherein the actions further comprise:
determining a plurality of different computing resources required to perform the plurality of types of tasks; and
determining a resource weight of each type, among the plurality of types of tasks, based on ratios between the plurality of different computing resources, the resource weight characterizing the required computing resource.

17. The device of claim 16, wherein determining the plurality of different computing resources comprises:
determining a plurality of reference bandwidths required in response to the acceleration device performing the plurality of types of tasks using a same resource;
determining a plurality of corresponding sizes of the plurality of types of tasks; and
determining the plurality of different computing resources based on the plurality of corresponding sizes and the plurality of reference bandwidths.

18. A computer program product stored on a non-transitory computer-readable medium and comprising machine-executable instructions that, when executed, cause a device to:
determine a target task to be assigned to a group of acceleration devices of a storage system, the acceleration devices being configured to handle a group of types of tasks;
determine a group of corresponding computing resources required or implicated to perform a group of corresponding task queues of the group of acceleration devices;
based on the group of computing resources for the group of corresponding task queues, select a target acceleration device from the group of acceleration devices; and
assign the target task to the target acceleration device.

19. The computer program product of claim 18, wherein the machine-executable instructions, when executed, further cause the device to:
receive write data;
divide the write data into a group of parts of data with a predetermined size; and
submit a request for a corresponding type, among the group of types, of tasks executed for the group of parts of data.

20. The computer program product of claim 19, wherein the group of types of tasks comprises at least two of the following: an encryption task, a decryption task, a compression task, a decompression task, or a hashing task.
